(19) United States
(12) Patent Application Publication
(10) Pub. No.: US 2015/0148183 A1
(43) Pub. Date: May 28, 2015

(54) PLANETARY GEARSET

(71) Applicant: Hyundai Motor Company, Seoul (KR)

(72) Inventor: Geum Muk CHAE, Hwaseong-si (KR)

(73) Assignee: Hyundai Motor Company, Seoul (KR)

(21) Appl. No.: 14/319,568

(22) Filed: Jun. 30, 2014

(30) Foreign Application Priority Data
Nov. 27, 2013 (KR) 10-2013-0145543

(51) Int. Cl. F16H 1/28

(52) U.S. Cl. CPC F16H 1/28
USPC 475/331

(57) ABSTRACT

A planetary gear set may include a carrier, pinion shafts and a shaft securing ring. The carrier may have shaft insertion holes formed substantially parallel to a rotation center shaft and spaced apart at a predetermined distance from the rotation center shaft, and a carrier groove formed in an outside surface of one side along a predetermined circle centered on the rotation center shaft. The pinion shafts may be respectively inserted in the shaft insertion holes, each pinion shaft having a pinion gear rotatably arranged on an outside circumference of the pinion shaft and a shaft slot formed in a region corresponding to the carrier groove. The shaft securing ring may be mounted to the carrier to have one side inserted in the carrier groove for securing the pinion shafts to the carrier.

### CROSS-REFERENCE TO RELATED APPLICATION

The present application claims priority of Korean Patent Application Number 10-2013-0145543 filed on Nov. 27, 2013, the entire contents of which application are incorporated herein for all purposes by this reference.

### BACKGROUND OF INVENTION

1. Field of Invention

The present invention relates to a planetary gear set. More particularly, the present invention relates to a planetary gear set having a sun gear, pinion gears and a ring gear, in which the pinion gears are rotatably mounted to pinion shafts and the pinion shafts are secured to a carrier.

2. Description of Related Art

In general, the planetary gear set is provided with a sun gear, a ring gear, pinion gears and a carrier assembly which connects the pinion gears. The carrier assembly has a carrier, and the pinion shafts secured to the carrier.

There are various methods of securing the pinion shafts to the carrier. Of the various methods, a typical method is forming a hole in each of the pinion shaft and the carrier, and a pin is inserted in the holes to secure the pinion shaft to the carrier.

FIG. 10 illustrates a cross-sectional view showing a secured state of the pinion shaft to the carrier wherein the planetary gear set is provided with a pinion shaft 110, a pinion gear 120, a carrier 130, and a securing pin 1000. The securing pin 1000 secures the pinion shaft 110 to the carrier 130 passed through the pinion shaft 110 and the carrier 130, for rotating the pinion gear 120 on the pinion shaft 110.

In the meantime, since the securing pin 1000 is provided to each of the pinion shafts 110 for securing the pinion shafts 110 to the carrier 130, an assembly cost increases, assembly defects of the pinion shaft 110 increases, and disassembly of the pinion shaft 110 is difficult.

The information disclosed in this Background section is only for enhancement of understanding of the general background of the invention and should not be taken as an acknowledgement or any form of suggestion that this information forms the prior art already known to a person skilled in the art.

### SUMMARY OF INVENTION

The present invention has been made in an effort to provide a planetary gear set having advantages of a reduced assembly cost, reduced assembly defects, and easy disassembly of the pinion shafts from the carrier. The present invention is directed to providing a planetary gear set which can reduce the assembly cost required for securing the pinion shafts to the carrier, can reduce the assembly defects, and can disassemble the pinion shafts from the carrier easily.

According to various aspects of the present invention, a planetary gear set may include a carrier having shaft insertion holes formed substantially parallel to a rotation center shaft and spaced apart at a predetermined distance from the rotation center shaft, and a carrier groove formed in an outside surface of one side thereof along a predetermined circle centered on the rotation center shaft, pinion shafts respectively inserted in the shaft insertion holes, each to have a pinion gear rotatably arranged on an outside circumference thereof and a shaft slot formed in a region corresponding to the carrier groove, and a shaft securing ring mounted to the carrier to have one side inserted in the carrier groove for securing the pinion shafts to the carrier.

The shaft securing ring may be formed to have a substantially circular shape corresponding to the carrier groove and have a cut-out portion. The carrier groove may have a ring securing recess formed therein, and the shaft securing ring may have a ring securing protrusion formed thereon to be seated in the ring securing recess.

The shaft securing ring may include a ring body portion to be disposed at a location closer to the rotation center shaft and having a thickness corresponding to a depth of the carrier groove, and a shaft securing portion formed as one unit with the ring body portion to be inserted in the shaft slots for securing the pinion shafts to the carrier. The shaft securing portion may be disposed at a location farther than the ring body portion with respect to the rotation center shaft.

The shaft securing portion may be formed along the ring body portion such that the shaft securing portion maintains a state in which the shaft securing portion is inserted in the shaft slots of the pinion shafts when the shaft securing portion is turned in a predetermined rotation range.

The carrier groove may have a ring securing recess formed away from the rotation center shaft, and the shaft securing ring may have a ring securing protrusion to be seated in the ring securing recess. The cut-out portion may be larger than a diameter of of one or each of the pinion shafts. The ring securing protrusion may be formed at a predetermined angle from the shaft insertion hole with reference to the rotation center shaft.

According to the present invention, a plurality of pinion shafts can be secured to the carrier rigidly by using one shaft securing ring. Accordingly, assembly cost can be reduced, and a maintenance expense may be reduced. Along with this, the securing or removing of the plurality of pinion shafts to/from the carrier by one turning action of the shaft securing ring can reduce an assembling expense and a disassemble time period.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a partial cross-sectional view illustrating an exemplary planetary gear set in accordance with the present invention.

FIG. 2 is a front view illustrating an exemplary shaft securing ring in an exemplary planetary gear set in accordance with the present invention.

FIG. 3 is a cross-sectional view of the shaft securing ring taken along the line A-A in FIG. 2.

FIG. 4 is a front view illustrating an exemplary carrier and pinion shafts in an assembled state in an exemplary planetary gear set in accordance with the present invention.

FIG. 5 is a cross-sectional view illustrating the carrier and the pinion shaft taken along the line B-B in FIG. 4.

FIG. 6 is a side view illustrating an exemplary shaft securing ring before being fastened to an exemplary carrier in accordance with the present invention.

FIGS. 7 and 8 are side views illustrating a process for fastening an exemplary shaft securing ring to an exemplary carrier in accordance with the present invention.

FIG. 9 is a side view illustrating an exemplary shaft securing ring fastened to an exemplary carrier in accordance with the present invention.

FIG. 10 is a partial cross-sectional view illustrating a state in which pinion shafts are secured to a carrier.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

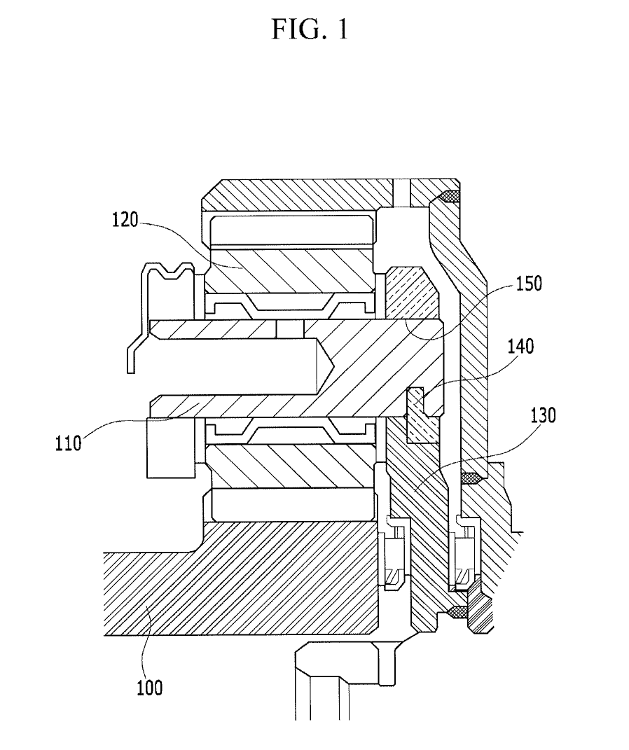

FIG. 1 is a partial cross-sectional view illustrating a planetary gear set in accordance with various embodiments of the present invention. Referring to FIG. 1, the planetary gear set includes a sun gear 100, pinion shafts 110, pinion gears 120, a carrier 130, and a shaft securing ring 140, and the carrier 130 has shaft insertion holes 150 formed therein for passing or inserting the pinion shafts 110, respectively.

The pinion shafts 110 have the pinion gears 120 rotatably mounted thereto respectively, such that the pinion gears 120 circumscribe to or circumvent the sun gear 100. And, the shaft securing ring 140 secures the pinion shafts 110 to the carrier 130.

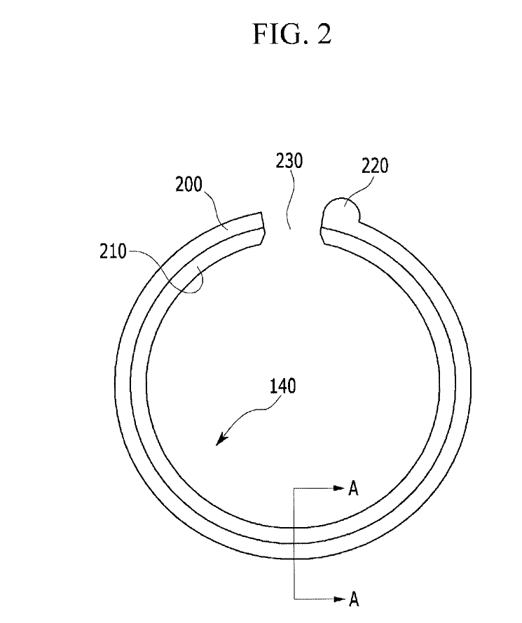

FIG. 2 is a front view illustrating a shaft securing ring in a planetary gear set in accordance with various embodiments of the present invention. Referring to FIG. 2, the shaft securing ring 140 of an annular ring shape has a cut-out portion 230 from the ring to form a discontinued portion of the ring. The cut-out portion 230 has a width larger than an outside diameter of the pinion shaft 110.

The shaft securing ring 140 has a ring body portion 210 formed along a circle with reference to a predetermined center point, and a shaft securing portion 200 formed as one unit with the ring body portion 210 protruded from an outside circumference of the ring body portion 210 in a radial direction.

Along with this, the shaft securing portion 200 has a ring securing protrusion 220 protruded such as in a radial direction in a semicircular form or in a substantially semicircular form from one side thereof.

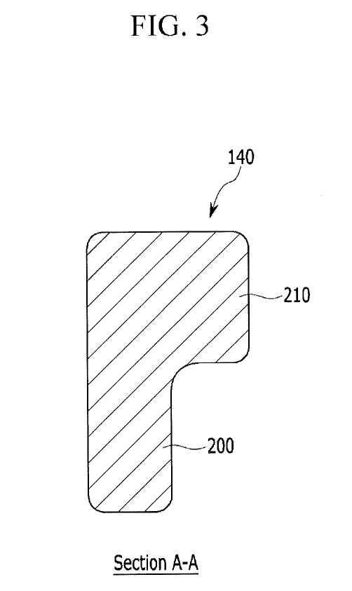

FIG. 3 is a cross-sectional view of the shaft securing ring taken along the line A-A in FIG. 2. Referring to FIG. 3, the shaft securing ring 140 includes the ring body portion 210 formed on a center side, and the shaft securing portion 200 formed on an outer side of the ring body portion 210 as one unit with the ring body portion 210, wherein the ring body portion 210 is formed thicker than the shaft securing portion 200. Referring to FIGS. 1 and 3, the shaft securing portion 200 is mounted on or to the carrier 130.

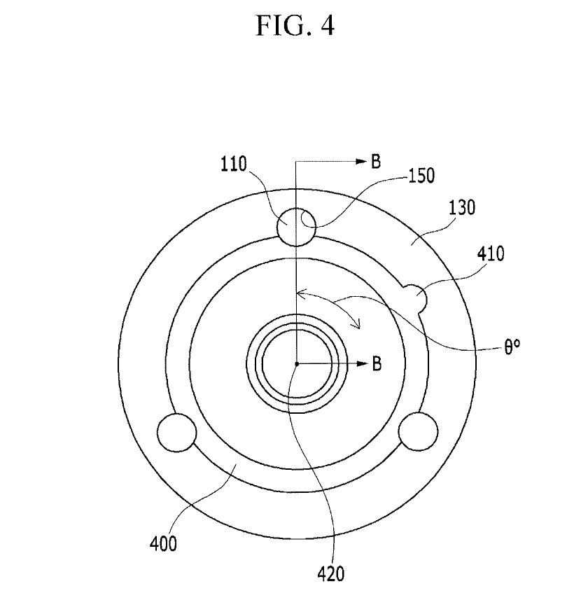

FIG. 4 is a front view illustrating a carrier and pinion shafts in accordance with various embodiments of the present invention, in an assembled state. Referring to FIG. 4, the carrier 130 is arranged to rotate centered on a rotation center shaft 420, and has an outside surface having a carrier groove 400 formed therein along a circle centered on the rotation center shaft 420.

Together with this, the carrier 130 has the shaft insertion holes 150 formed in a direction parallel or substantially parallel to the rotation center shaft 420 for inserting the pinion shafts 110 therein, respectively.

The shaft insertion hole 150 and the carrier groove 400 have an overlapped area such that the pinion shaft 110 protrudes toward the carrier groove 400 in a state the pinion shaft 110 is inserted in the shaft insertion hole 150. Moreover, the shaft insertion hole 150 is formed at a plurality of places such as three places matched or corresponding to the carrier groove 400 on a circle centered on the rotation center shaft 420 for inserting the pinion shaft 110 in each of the shaft insertion holes 150.

And, the carrier groove 400 has a recess such as a semicircular ring securing recess 410 formed therein between two of the shaft insertion holes 150. That is, the ring securing recess 410 is formed at a predetermined angle 0 from one of the shaft insertion holes 150.

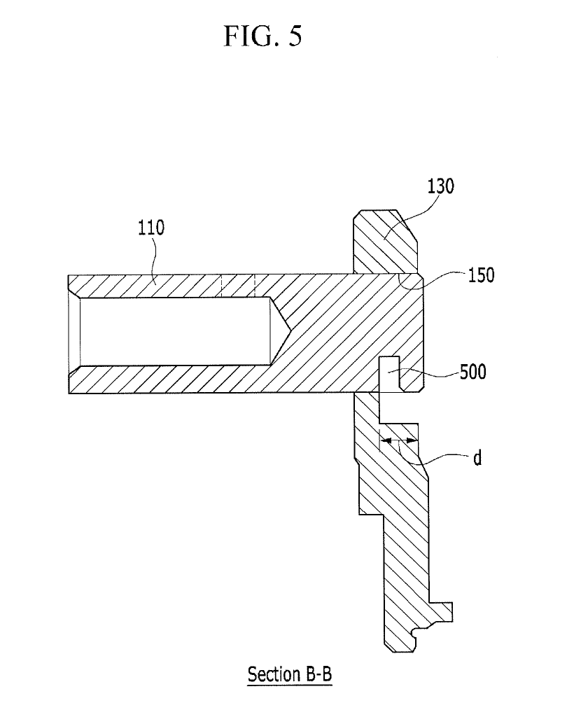

FIG. 5 is a cross-sectional view illustrating the carrier and the pinion shaft taken along the line B-B in FIG. 4. Referring to FIG. 5, the carrier 130 has the shaft insertion holes 150 formed in a direction parallel to the rotation center shaft 420, to have the pinion shafts 110 inserted therein, respectively.

As shown, the pinion shaft 110 has an end portion with a shaft slot 500 formed in an outside circumference thereof, such that the carrier groove 400 in the carrier 130 and the shaft slot 500 form a cross section the same or substantially the same as the cross section of the shaft securing ring 140.

In various embodiments of the present invention, a thickness or a depth may be defined in a length direction of the pinion shaft.

The carrier groove 400 has a predetermined depth d, and the ring body portion 210 of the shaft securing ring 140 has a thickness the same or substantially the same as a thickness of the carrier groove 400. Along with this, the shaft securing portion 200 of the shaft securing ring 140 has a thickness the same or substantially the same as a thickness of the shaft slot 500.

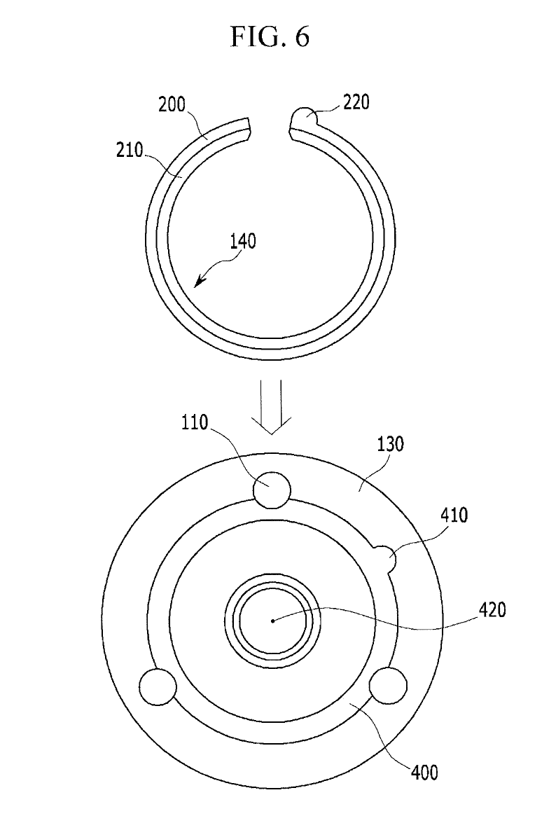

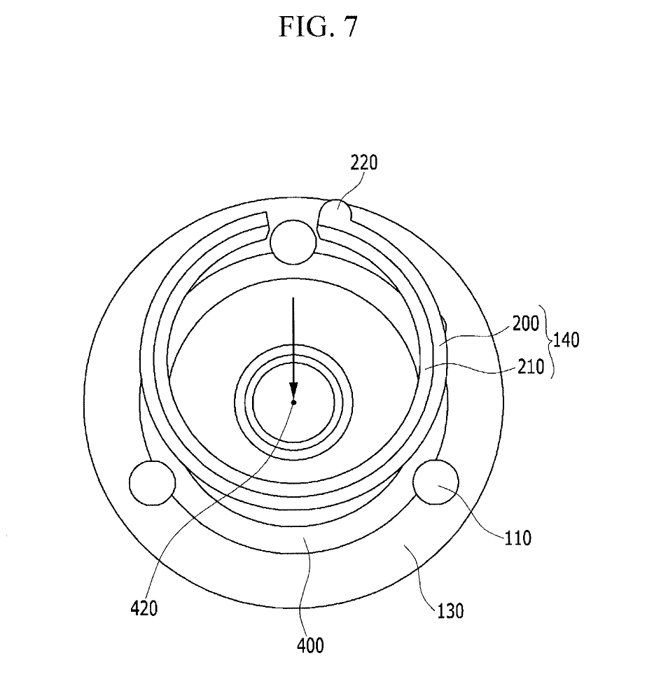

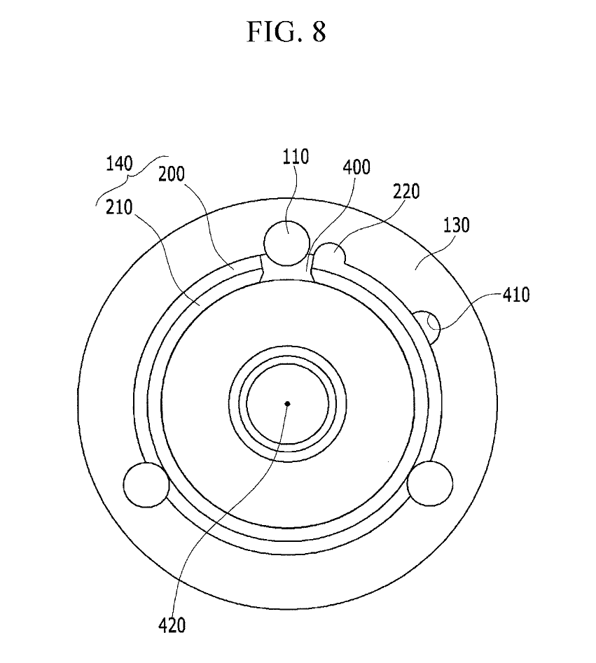

FIG. 6 is a side view illustrating a shaft securing before being fastened to a carrier in accordance with various embodiments of the present invention, and FIGS. 7 and 8 are side views illustrating a process for fastening a shaft securing ring to a carrier in accordance with various embodiments of the present invention.

Referring to FIG. 6, the shaft securing ring 140 and the carrier 130 are provided, and, then, the shaft securing ring 140 is moved toward the carrier groove 400 in the carrier 130. Referring to FIGS. 7 and 8, the shaft securing ring 140 is inserted into the ring securing recess 410 so that the shaft securing portion 200 of the shaft securing ring 140 is inserted into the shaft slots 500 in two of the pinion shafts 110.

In this case, the shaft securing ring 140 is coupled to the carrier 130 such that one of the three pinion shafts 110 passes through the cut-out portion 230 of the shaft securing ring 140.

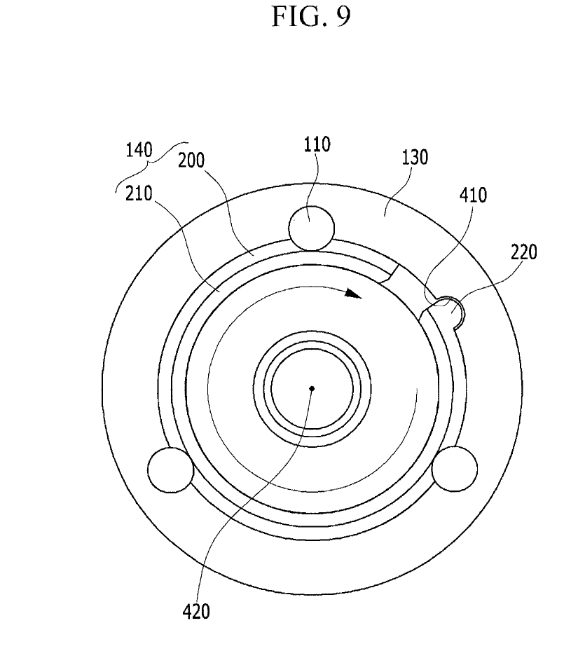

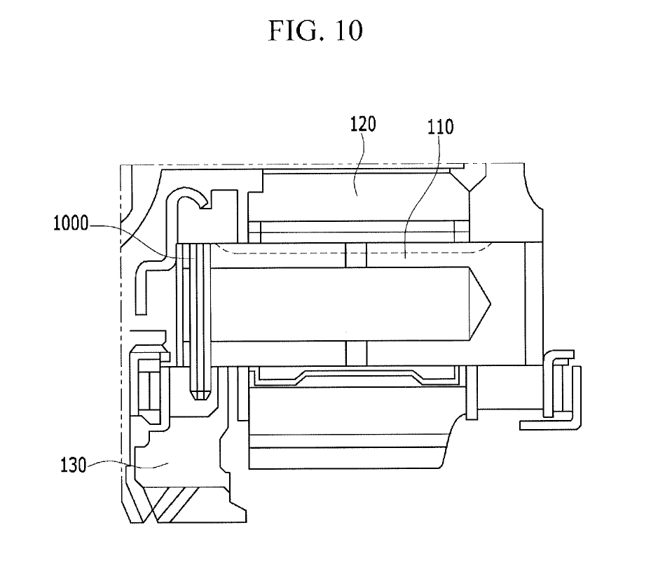

FIG. 9 is a side view illustrating a shaft securing ring fastened to a carrier in accordance with various embodiments of the present invention. Referring to FIG. 9, the shaft securing ring 140 is turned by a preset angle centered on the rotation center shaft 420 from a state of FIG. 8 to insert the ring securing protrusion 220 into the ring securing recess 410.

Eventually, the shaft securing ring 140 is secured to the carrier 130, securing the pinion shafts 110 in a direction of the rotation center shaft 420 such that the pinion shafts 110 cannot fall off the carrier 130.

For convenience in explanation and accurate definition in the appended claims, the terms “inside” or “outside”, and etc. are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A planetary gear set comprising:
a carrier having shaft insertion holes formed substantially parallel to a rotation center shaft and spaced apart at a predetermined distance from the rotation center shaft, and a carrier groove formed in an outside surface of one side thereof along a predetermined circle centered on the rotation center shaft;
pinion shafts respectively inserted in the shaft insertion holes, each to have a pinion gear rotatably arranged on an outside circumference thereof and a shaft slot formed in a region corresponding to the carrier groove; and
a shaft securing ring mounted to the carrier to have one side inserted in the carrier groove for securing the pinion shafts to the carrier.

2. The planetary gear set of claim 1, wherein the shaft securing ring is formed to have a substantially circular shape corresponding to the carrier groove and have a cut-out portion.

3. The planetary gear set of claim 2, wherein the carrier groove has a ring securing recess formed therein, and the shaft securing ring has a ring securing protrusion formed thereon to be seated in the ring securing recess.

4. The planetary gear set of claim 1, wherein the shaft securing ring includes:
a ring body portion to be disposed at a location closer to the rotation center shaft and having a thickness corresponding to a depth of the carrier groove; and
a shaft securing portion formed as one unit with the ring body portion to be inserted in the shaft slots for securing the pinion shafts to the carrier.

5. The planetary gear set of claim 4, wherein the shaft securing portion is disposed at a location farther than the ring body portion with respect to the rotation center shaft.

6. The planetary gear set of claim 4, wherein the shaft securing portion is formed along the ring body portion such that the shaft securing portion maintains a state in which the shaft securing portion is inserted in the shaft slots of the pinion shafts when the shaft securing portion is turned in a predetermined rotation range.

7. The planetary gear set of claim 2, wherein the carrier groove has a ring securing recess formed away from the rotation center shaft, and the shaft securing ring has a ring securing protrusion to be seated in the ring securing recess.

8. The planetary gear set of claim 2, wherein the cut-out portion is larger than a diameter of one or each of the pinion shafts.

9. The planetary gear set of claim 3, wherein the ring securing protrusion is formed at a predetermined angle from the shaft insertion hole with reference to the rotation center shaft.
